(19) United States
(12) Patent Application Publication
(10) Pub. No.: US 2003/0177344 A1
(43) Pub. Date: Sep. 18, 2003

(54) Configuration controller and method for initializing a data-processing device

(76) Inventor: Arthur E. Harvey IV, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/100,859

(22) Filed: Mar. 18, 2002

(51) Int. Cl. G06F 15/177

(52) U.S. Cl. 713/1

(57) ABSTRACT

A dedicated configuration controller includes a configuration memory and a configuration processing unit. The memory stores configuration data for a data-processing device having a device processing unit, and the configuration processing unit couples the configuration data from the memory to the device processing unit before or during the initialization of the data-processing device. Such a configuration controller can reduce the time it takes to reconfigure a data-processing device by allowing a network administrator to modify the configuration data with minimum interruption to the operation of the device. Furthermore, such a configuration controller can often save the network administrator time by allowing him to simultaneously modify the configuration data of multiple data-processing devices. Moreover, one can program the controller to offload post-initialization tasks from the device processing unit.

### BACKGROUND OF THE INVENTION

Data-processing devices such as personal computers (PCs), data servers, and data routers are integral components of today's multi-data-network systems. Typically, a PC allows an operator to generate and manipulate data, a server is a common data-storage location accessible to PCs that are connected to each other and to the server to form a data network, and a router allows data transfers between networks.

When one such as a network administrator modifies a data-processing device or its external environment, then he must often reconfigure the device by modifying the device's configuration data. Configuration data is the information that configures a data-processing device to operate in a specified manner. For example, configuration data for a PC often includes the basic-input-output-system (BIOS) data that is typically stored in a memory chip on the PC's mother board. During “boot,” i.e., initialization, of the data-processing device, the device's central processing unit (CPU) loads respective portions of the configuration data into its memory and into the memories of peripheral hardware components such as an input/output controller or a disk drive. Once the configuration data is loaded, it configures the CPU and the peripheral components to operate in a specified manner. But if the administrator modifies the data-processing device by, for example, adding a disk drive, then he or the device itself typically must modify the configuration data so that the disk drive can operate as part of the device. Similarly, if the administrator modifies the device's external environment by, for example, adding a communications protocol to a network that incorporates the device, then he or the device itself typically must modify the device's configuration data so that the device can communicate using the protocol.

Unfortunately, as discussed below in conjunction with FIG. 1, a data-processing device may be slowed or disabled while the configuration data is being modified. Furthermore, if the network administrator needs to make the same modification to the configuration data of multiple devices, then he typically must modify the devices one at a time.

FIG. 1 is a diagram of a conventional multi-data-network system 10 that includes a number, here four, of local-area data networks (LANs) 12a-12d and a router 14 that interconnects the LANs 12a-12d to each other and to the internet. The LAN 12a includes a data server 16a, a number, here three, of PCs 18a, 20a, and 22a, and a hub 24a that interconnects the PCs and the server. The LAN 12a also includes a terminal 26a that allows a network administrator (not shown) to monitor and reconfigure the server 16a using a command-line user interface. Although not shown in detail, the other LANs 12b 12d are similar to the LAN 12a. In addition to the LANs 12a-12d and the router 14, the system 10 includes a terminal 28 that allows the administrator to monitor and reconfigure the router 14 via a command-line interface.

The router 14 and the server 16a each include respective CPUs 30 and 32a and respective configuration memories 34 and 36a that respectively store router- and server-configuration data. The PCs 18a, 20a, and 22a may also each include respective CPUs and configuration memories (not shown), but a discussion of the PCs in this context is omitted for clarity. During initialization of the router 14—such initialization typically occurs when the router 14 is powered on or is initialized without turning off the power—the CPU 30 loads respective portions of the router configuration data from the memory 34 into the router-CPU memory (not shown) and the memories of peripheral hardware components such as I/O-port controllers (not shown). After the initialization is complete, the router 14 operates in the configuration dictated by the router-configuration data. Similarly, during initialization of the server 16a, the CPU 32a loads respective portions of the server-configuration data from the memory 36a into the server-CPU memory (not shown) and the memories of peripheral hardware components. After the initialization is complete, the server 16 operates in the configuration dictated by the server-configuration data.

Unfortunately, the network administrator typically must take the server 16a offline to reconfigure it. Typically, the administrator can reconfigure the server 16a only while it is initializing. Specifically, to reconfigure the server 16a, the administrator starts the initialization of the server 16a, temporarily halts the initialization and modifies the configuration data via the terminal 26a, and then allows the initialization to finish with the modified configuration data. Alternatively, the server CPU 32a can automatically modify the configuration data during initialization such as when it senses a newly installed hardware component. Once the initialization is finished, the server 16a operates in the configuration dictated by the modified configuration data. But unfortunately, the server 16a, and thus the data it stores, are inaccessible to the PCs 18a, 20a, and 22a during this reconfiguration procedure. Furthermore, although not discussed in detail, a similar discussion applies to modifying the configuration data in the PCs 18a, 20a, and 22a.

And although the network administrator can often reconfigure the router 14 without taking it offline, the router may operate at a reduced speed while the administrator modifies the configuration data in the configuration memory 34. Typically, the administrator can reconfigure the router 14 only via the router CPU 30. Specifically, to reconfigure the router 14, the administrator enters modifications to the configuration data into the CPU 30 via the terminal 28. The CPU 30 then writes the modified configuration data to the memory 34. The CPU 30 may also read data from the memory 34 if the administrator wants to check the router's current configuration settings, and may check the modifications for compatibility with the hardware components (not shown) of the router. This writing, reading, and checking consumes data-processing time, and thus reduces the amount of time that the CPU 30 has to route data between the networks 12a-12d and the internet. Therefore, the router 14 may take longer to route data, and thus may slow down the operation of the server 16a, the PCs 18a, 20a, or 22a or, other network devices (not shown) that are transferring data via the router.

Moreover, if the network administrator needs to reconfigure multiple routers 14 or multiple servers 16, then he typically must reconfigure each router or server separately. For example, if the administrator must reconfigure ten servers 16 in identical fashion, then he must make the same modifications to the configuration data ten times, one time for each server.

### SUMMARY OF THE INVENTION

In one embodiment of the invention, a configuration controller includes a memory and a configuration CPU. The memory stores configuration data for a data-processing device having a device CPU, and the configuration CPU couples the configuration data from the memory to the device CPU before or during initialization of the data-processing device.

Such a configuration controller can reduce the time it takes to reconfigure a data-processing device by allowing a network administrator to modify the configuration data before the device reconfigures itself. For example, to reconfigure a server, the administrator modifies the configuration data in the controller memory while the server is operating in its unmodified configuration. Then, the administrator initializes the server and the server CPU loads the modified configuration data from the controller memory while the server is initializing. Consequently, the server is offline for significantly less time than if the administrator modified the configuration data by interrupting the server initialization process. To reconfigure a router, the administrator modifies the configuration data in the controller memory while the router is operating in its unmodified configuration, and then instructs the router CPU to load the modified configuration data. This significantly reduces the load on the router CPU, and thus slows the router less than if the administrator modified the configuration data via a terminal. Alternatively, the administrator can reconfigure the router by initializing it in a manner similar to that described above for reconfiguring the server.

Furthermore, such a configuration controller can often save the network administrator time by allowing him to simultaneously modify the configuration data of multiple data-processing devices. For example, if the administrator needs to reconfigure multiple networked servers in the same manner, then he can enter the modified configuration data once and load it into the servers' respective configuration controllers from one of the servers or from a PC that is networked to the servers.

### BRIEF DESCRIPTION OF THE DRAWINGS

FIG. 1 is a diagram of a conventional multi-network-data system.

FIG. 2 is a diagram of a server that includes a configuration controller according to an embodiment of the invention.

FIG. 3 is a diagram of a router that includes a configuration controller according to an embodiment of the invention.

FIG. 4 is a diagram of the configuration controller of FIGS. 2 and 3 according to an embodiment of the invention.

### DESCRIPTION OF THE PREFERRED EMBODIMENTS

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

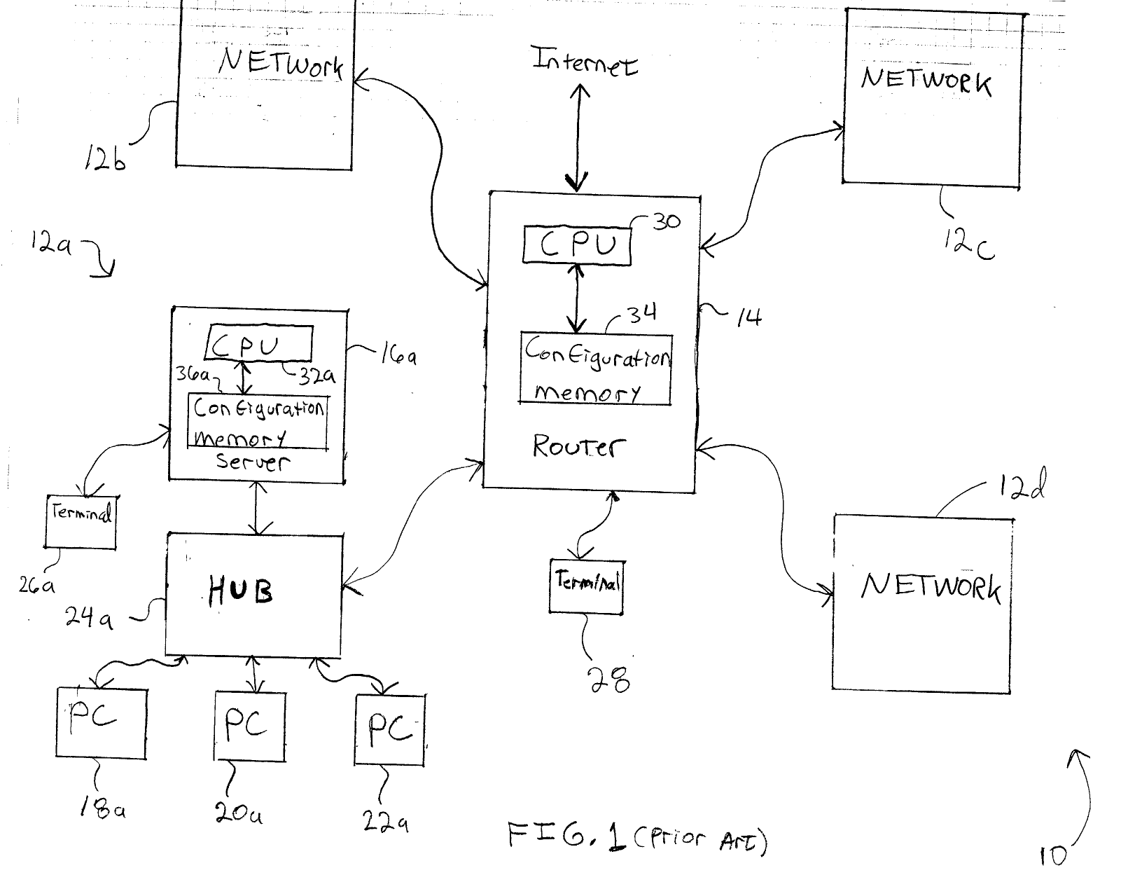

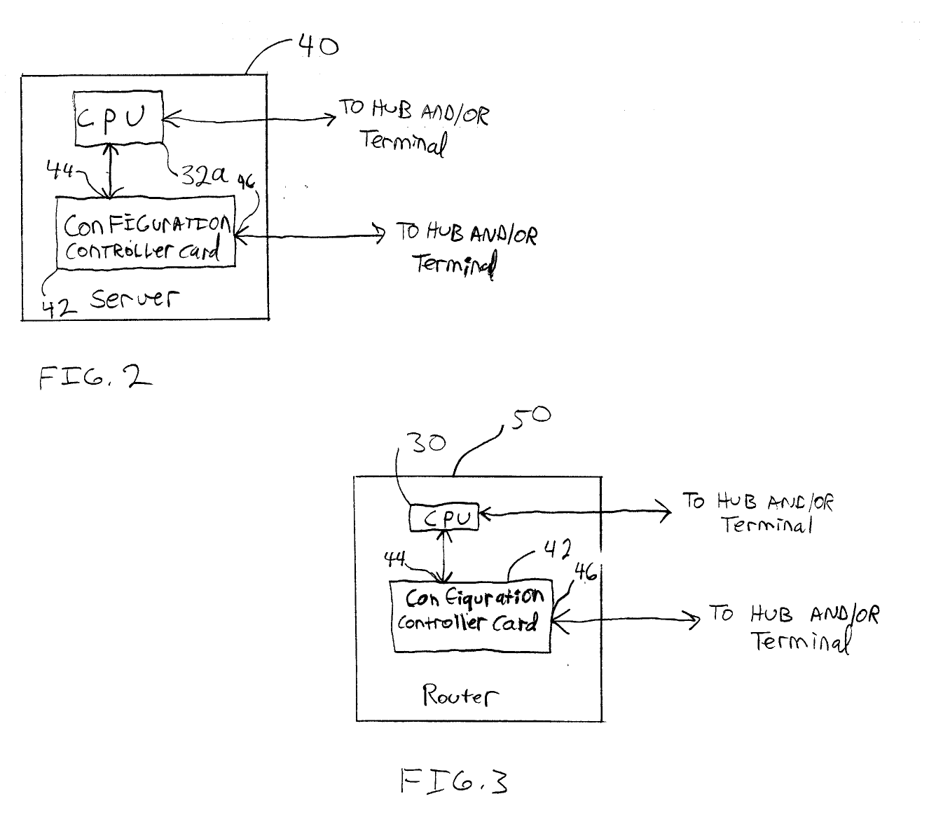

FIG. 2 is diagram of a server 40 that includes a configuration controller, here a configuration controller card 42, according to an embodiment of the invention, where like numerals are used in FIGS. 1 and 2 for like components. The controller card 42, which communicates with the server's CPU 32a via a hardware interface 44, can replace the configuration memory 36a of FIG. 1, and, as discussed below in conjunction with FIG. 4, allows a network administrator (not shown) to modify the server's configuration data via a hardware interface 46 without rebooting the server. Furthermore, the card 42 allows the administrator to modify the configuration data of multiple servers 40 by entering the modified data only once.

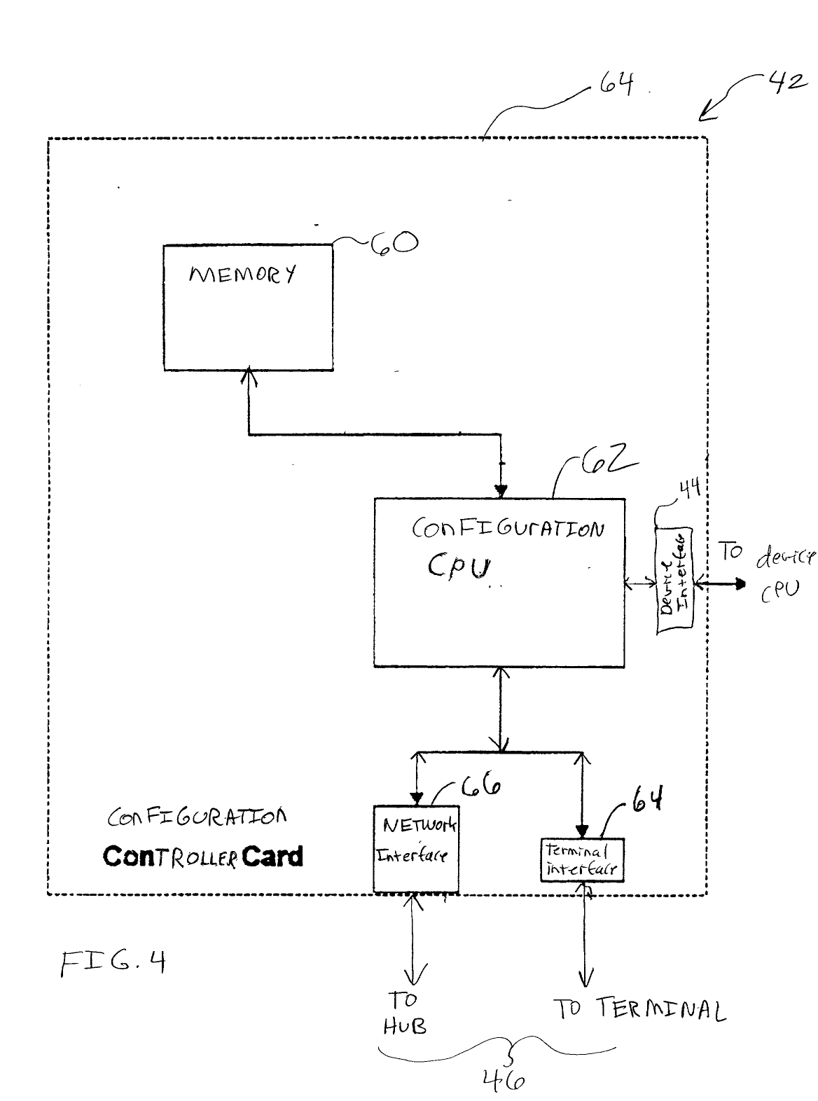

FIG. 3 is diagram of a router 50 that includes a configuration controller, here the configuration-controller card 42 of FIG. 2, according to an embodiment of the invention, where like numerals are used in FIGS. 1-3 for like components. The controller card 42, which communicates with the router's CPU 30 via the interface 44, can replace the configuration memory 34 of FIG. 1, and, as discussed below in conjunction with FIG. 4, allows a network administrator (not shown) to modify the router's configuration data via the interface 46 without interfering with the router's normal operation. Furthermore, the card 42 allows the administrator to modify the configuration data of multiple routers 50 by entering the modified data only once.

FIG. 4 is a diagram of the configuration-controller card 42 of FIGS. 2 and 3 according to an embodiment of the invention. The card 42 includes the hardware interfaces 44 and 46, a memory 60, and a configuration CPU 62, which are mounted to a printed-circuit board 64. The interface 44 is a PCI, Ethernet, or other hardware interface that allows the configuration CPU 62 to communicate with the CPU of the data-processing device in which the card 42 is installed. The interface 46 includes a terminal interface 64, such as an RS-232 serial port, and a network interface 66 such as a 10/100 Base T (BT) Ethernet port. The interface 64 allows the network administrator (not shown) to access the CPU 62 via a terminal (not shown in FIG. 4), and the interface 66 allows the CPU 62 to communicate directly—as opposed to indirectly via the device CPU—with networked devices (not shown in FIG. 4). The memory 60 stores the configuration data for both the card 42 and the device in which the card is installed, and can incorporate any type of memory such as flash, SRAM, DRAM, or a disk drive. The CPU 62 provides the device's configuration data from the configuration memory 60 to the device CPU during initialization of the device, and allows the administrator—via the interfaces 64 and 66—to modify the device's configuration data stored in the configuration memory. The CPU 62 can include any type of processor, memory, and peripheral hardware (not shown), and can be programmed to support any type of user interface such as a command-line interface (via the terminal interface 64) or a hypertext (web-page) interface (via the network interface 66), which can have built-in safeguards for preventing the administrator from making inadvertent changes to the configuration data.

Referring to FIGS. 2 and 4, the operation of the configuration-controller card 42 when installed in the server 40 is discussed according to an embodiment of the invention.

During initialization of the server 40, the server's CPU 32a “looks” to the configuration memory 60 for the server's configuration data instead of looking to an on-board configuration memory such as the memory 36a (FIG. 1). Therefore, once the controller card 42 initializes, the configuration CPU 62 provides the server configuration data from the memory 60 to the server CPU 32a. In one alternative, the configuration memory 60 points to another memory (not shown) that stores the server-configuration data. In another alternative, the memory 60 stores basic server-configuration data such as BIOS, but points to another memory (not shown) that stores higher-level configuration data such as the image of the server's operating system. In yet another alternative, the memory 60 stores all of the server's configuration data including the higher-level configuration data. After the server 40 initializes, the server CPU 32a need not communicate further with the controller card 42, although it may continue to do so as discussed below.

As discussed above, to modify the server configuration data stored in the configuration memory 60, the network administrator need not reboot the server 40, and thus need not take the server off line. While the server 40 is operating in a post-initialization mode and the controller card 42 is installed in the server, the administrator can modify the server's configuration data in the configuration memory 60 via the interface 64 or 66 without accessing the server CPU 32a. Alternatively, the administrator can remove the controller card 42 while the server 40 is operating—sometimes called “hot-swapping” a card—in a post-initialization mode, modify the server's configuration data, and then reinstall the controller card 42. Consequently, the administrator can modify the configuration data without rebooting or otherwise interfering with the operation of the server 40. And even though the administrator must often reboot the server so that the server CPU 32a will reconfigure the server according to the modified configuration data, the server is offline for a minimum time because the administrator need not interrupt the initialization procedure to modify the configuration data.

Furthermore, because the controller card 42 includes the network interface 66, the administrator can modify the server configuration data in the configuration memory 60 from a remote location. For example, the administrator can modify the configuration data from his home PC (not shown in FIGS. 2 and 4) via the internet.

Moreover, the controller card 42 allows the network administrator to reconfigure multiple servers 40 by modifying the configuration data only once. For example, suppose there are ten servers 40 in a network, a respective controller card 42 is installed in each server, and the administrator needs to reconfigure all ten servers in an identical fashion. The administrator can modify the server configuration data using a PC (not shown) that is networked to the servers, and then simultaneously load the modified configuration data into the memories 60 via the PC. Or, the administrator can modify the configuration data in one of the memories 60 via a server terminal (FIG. 1), and then load the contents of that memory into the other memories 60. Alternatively, the administrator can load the modified configuration data into the memory 60 of a single card 42, install the card in one of the servers, reboot the server so that it will reconfigure itself with the modified configuration data, hot-swap the card 42 out of the server, and repeat this procedure with the remaining servers until they are all reconfigured.

Still referring to FIGS. 2 and 4, the controller card can be designed/programmed to have operational features other than those described above.

The configuration CPU 62 can be programmed to accept modifications to the server-configuration data from the server CPU 32a, or to accept one or more software plug-ins, so that the server 40 can make changes to its own configuration. For example, a user may alter the configuration of the server 40 to allow the user to log onto the server. The server 40 then provides this configuration modification to the configuration memory 60 via the configuration CPU 62 so that after its next initialization, the server will “recognize” the user. Furthermore, a plug-in is typically the configuration data that the server 40 needs to operate a peripheral hardware component such as a disk drive. By including the plug-in in the configuration data, one typically can install the peripheral component after initialization of the server 40 and operate the component without rebooting the server. For example, if the configuration CPU 62 provides the plug-in for a new disk drive to the server 40 even if the drive is not installed in the server during initialization, the server is configured to operate the drive if it is installed post-initialization. And if the server-configuration data does not include a plug-in for a particular component, then the administrator or server 40 can load the plug-in into the configuration memory 60.

Because both the administrator and the server 40 may be able to modify the configuration data in the configuration memory 60, the configuration CPU 62 may implement a priority system such that if both the administrator and server try to modify the configuration data at the same time, only one will have priority to do so.

Before accepting modified configuration data from either the network administrator or the server 40, the configuration CPU 62 can check with the server CPU 32a to make sure that the server supports the configuration represented by the modified data. For example, if the administrator attempts to modify the configuration data such that the server 40 will recognize a disk drive, the configuration CPU 62 will check to make sure that the disk drive is installed in the server. If so, the configuration CPU 62 will accept the modified configuration data. If not, the CPU 62 will reject the modified configuration data and supply an error message that informs the administrator that the data is being rejected because the disk drive is not installed in the server.

The controller card 42 can also be programmed to work with servers 40 that may each have a different hardware configuration. The servers 40 that the card 42 is designed for may have similar, but not identical, hardware configurations. Therefore, the configuration memory 60 can store configuration data suitable for all these hardware configurations. During initialization of the server 40, the card 42 can detect the server's current hardware configuration via the interface 44, and provide the appropriate portions of the configuration data to the server CPU 32a based on the detected configuration.

Furthermore, in addition to storing the server configuration data, the controller board 42 can offload post-initialization tasks from the server 40 to increase the efficiency of the server CPU 32a by letting it focus on fewer tasks. For example, suppose the administrator wants the server 40 to implement a periodic alarm/timer such as every thirty minutes determining how many users are logged onto the server. He can program the configuration CPU 62 to poll the server CPU 32a for this information and then store it in the configuration memory 60 or provide it via the terminal 26a (FIG. 1). In addition, if the configuration CPU 62 includes an interrupt handler (not shown), then the administrator can program the interrupt handler to handle interrupts that would normally go to the server CPU 32a. Of course this would be in addition to the configuration-controller interrupts that the configuration CPU 62 already handles. Furthermore, the configuration CPU 62 can be programmed to handle server event logs.

Moreover, if the configuration memory 60 is large enough, the administrator can configure the server CPU 32 to access the configuration memory for post-initialization operation, thus increasing the amount of memory available to the server CPU. This would effectively increase the size of the server's working memory (typically RAM).

Referring to FIGS. 3 and 4, the operation of the controller card 42 when installed in the router 50 is discussed according to an embodiment of the invention.

In a manner similar to that discussed above for the server 40, during initialization of the router 50, the router's CPU 30 “looks” to the configuration memory 60 for the router's configuration data instead of looking to an on-board configuration memory such as the memory 34 (FIG. 4). Alternatively, because the administrator can reconfigure the router 50 without rebooting it, he can also instruct the configuration CPU 62 to load modified configuration data from the configuration memory 60 (or from a memory to which the memory 60 points) into the router CPU 30 while the router is operating in a post-initialization mode.

As discussed above, to modify the router configuration data stored in the configuration memory 60, the administrator need not reboot the router 50, take the router offline, or interfere with the router's post-initialization operation. While the router 50 is operating in a post-initialization mode and the controller card 42 is installed in the router, the administrator can modify the router's configuration data in the memory 60 via the interface 64 or 66 without accessing the router CPU 30. Alternatively, the administrator can hot-swap the card 42 while the router 50 is operating in a post-boot mode, modify the router's configuration data, and then reinstall the card after he has modified the data. Consequently, the administrator can modify the configuration data without rebooting or otherwise interfering with the operation of the router 50. And even though the administrator typically must load the modified configuration data from the memory 60 into the router CPU 30 to reconfigure the router 50, such loading typically takes a relatively short period of time. Consequently, this loading slows the operation of the router 50 for a minimum time that is much less than the time it would take the administrator to modify the configuration data via a terminal and the router CPU 30.

Furthermore, when installed in the router 50, the controller card 42 can provide operational features similar to those it provides when installed in the server 40 (FIG. 2) as discussed above, and can provide additional operation features as discussed below. For example, the network administrator can provide additional security to the router 50 by removing the configuration controller card 42 after the router 50 has initialized or has been reconfigured. In a conventional router, one can typically access the configuration settings while the router is operating in a post-initialization mode. Therefore, one could determine how the router routes data, and use this information for elicit purposes such as to intercept confidential data. But one can design the router 50 such that the configuration settings are only accessible when the card 42 is installed. Therefore, to prevent unauthorized access to the router's configuration settings, the administrator can load the modified configuration data into the memory 60 of a single card 42, install the card in the router 50, reboot the router or reconfigure it while it is operating in a post-initialization mode, and then hot-swap the card 42 out of the router. To further increase security, the administrator can key the card 42 to the router 50 with an electronic key so that only that card can be used to access or reconfigure the router's settings.

Furthermore, the configuration controller card 42 would typically not store configuration data for dynamic router settings that are intended to change based on the router's post-initialization environment. For example, the configuration memory 60 would typically not store settings for a virtual local-area network (VLAN) or a trunk. VLANs are mutually exclusive groupings of router ports (not shown), i.e., one group cannot “talk” to another group. Trunks are multiple router ports configured to work together as a single port, i.e., ten 10 BT ports combined into a trunk that acts as a single 100 BT port. The router 50 creates VLANs and trunks dynamically, i.e., “on the fly,” depending on the operating parameters of the system in which the router is installed so as to route data in the most efficient manner. Consequently, because such dynamic settings depend on the system's operating parameters, it makes little sense to save specific dynamic settings in the configuration memory 60. But of course the memory 60 can store configuration data that allows the router 50 to generate such dynamic settings.

Referring to FIGS. 2-4, other embodiments of the controller card 42 are envisioned. For example, the board 64 may be omitted, and the interfaces 44, 64, and 66, the memory 60, and the CPU 62 may be located on the mother board or another board of the server 40 or router 50. Alternatively, the card 42 may be located remotely from the server 40 or router 50, and one or more of the interfaces 44, 64, and 66 may be wireless. Furthermore, although described as being used with a server 40 or router 50, the card 42 can be used with any other software-configurable device such as a PC.

What is claimed is:

1. A configuration controller, comprising:
a configuration memory operable to store configuration data for a data-processing device having a device processing unit; and
a configuration processing unit coupled to the configuration memory and operable to couple the configuration data to the device processing unit before or during initialization of the data-processing device.

2. The configuration controller of claim 1, further comprising:
a circuit board; and
wherein the configuration memory and the configuration processing unit are mounted to the circuit board.

3. The configuration controller of claim 1, further comprising a connector operable to couple the configuration processing unit to the device processing unit.

4. The configuration controller of claim 1, further comprising a hardware interface coupled to the configuration processing unit.

5. A data-processing device, comprising:
a device processing unit; and
a configuration controller operable to be coupled to the device processing unit and including,
a configuration memory operable to store configuration data for the device processing unit, and
a configuration processing unit coupled to the configuration memory and operable to provide the configuration data to the device processing unit before or during initialization of the device processing unit.

6. The data-processing device of claim 5, further comprising:
a peripheral hardware component coupled to the device processing unit;
wherein the configuration memory is operable to store peripheral-configuration data for the peripheral component; and
wherein the configuration processing unit is operable to provide the peripheral-configuration data to the device processing unit before or during initialization of the peripheral component.

7. The data-processing device of claim 5, further comprising:
a first connector coupled to the device processing unit; and
wherein the configuration controller further includes,
a circuit board,
a second connector mounted to the circuit board, coupled to the configuration processing unit, and operable to mate with the first connector, and
wherein the configuration memory and configuration processing unit are mounted to the circuit board.

8. The data-processing device of claim 5 wherein the configuration controller further includes:
a removable circuit board; and
wherein the configuration memory and configuration processing unit are mounted to the circuit board.

9. The data-processing device of claim 5, further comprising:
a first hardware configuration interface; and
wherein the configuration controller further includes a second hardware configuration interface mounted to the circuit board and operable to communication with the first interface.

10. The data-processing device of claim 5, further comprising:
a first external-communication hardware interface coupled to the device processing unit; and
wherein the configuration controller further includes a second external-communication hardware interface coupled to the configuration processing unit.

11. The data-processing device of claim 5 wherein the configuration memory is further operable to store a first operating system for the configuration processing unit and a second operating system for the device processing unit.

12. A data network, comprising:
a data-processing device, including,
a device processing unit,
a first network hardware interface coupled to the device processing unit, and
a configuration controller operable to be coupled to the device processing unit and including,
a configuration memory operable to store configuration data for the device processing unit, and
a configuration processing unit coupled to the configuration memory and operable to provide the configuration data to the device processing unit before or during initialization of the device processing unit.

13. The network of claim 12 wherein the data-processing device comprises a data server.

14. The network of claim 12 wherein the processing device comprises a data router.

15. The network of claim 12 wherein the processing device comprises a personal computer.

16. The network of claim 12 wherein the configuration controller comprises a second network hardware interface that is separate from the first network hardware interface.

17. The network of claim 12, further comprising:
a data-entry terminal; and
wherein the configuration controller is operable to be coupled to the data-entry terminal.

18. A method, comprising:
providing configuration data to a data-processing device having a device processing unit via a configuration processing unit that is independent of the device processing unit; and
initializing the data-processing device with the configuration data.

19. The method of claim 18, further comprising uncoupling the configuration processing unit from the device processing unit after initializing the data-processing device and while the data-processing device is operating in a post-initialization mode.

20. A method, comprising:
initializing a computer with configuration data; and
altering the configuration data after initializing the computer and while the computer is operating in a post-initialization mode.

21. The method of claim 20, further comprising providing the configuration data to a computer processing unit via a configuration processing unit that is independent of the computer processing unit.

22. The method of claim 20 wherein:
initializing the computer comprises initializing a computer processing unit; and
altering the configuration data comprises altering the configuration data without accessing the computer processing unit.

23. The method of claim 20 wherein altering the configuration data comprises altering the configuration data via a configuration processing unit that is independent of a computer processor unit.

24. The method of claim 20 wherein the computer comprises a data server.

25. The method of claim 20 wherein the computer comprises a personal computer.

26. A method, comprising:
initializing a data-processing device with configuration data, the data-processing device having a device processing unit; and
altering the configuration data after initializing the data-processing device and while the data-processing device is operating in a post-initialization mode without accessing the device processing unit.

27. The method of claim 26, further comprising providing the configuration data to the data-processing device via a configuration processing unit that is independent of the device processing unit.

28. A method, comprising:
initializing a data-processing device having a device processing unit with configuration data received from a configuration processing unit that is independent of the device processing unit;
requesting that the configuration processing unit alter the configuration data after initializing the data-processing device and while the data-processing device is operating in a post-initialization mode; and
determining whether the data-processing device supports the configuration represented by the requested alteration to the configuration data.

29. The method of claim 28, further comprising rejecting the request if the data-processing device does not support the configuration represented by the requested alteration to the configuration data.

30. The method of claim 28, further comprising altering the configuration data as requested if the data-processing device does support the configuration represented by the requested alteration to the configuration data.

31. The method of claim 28 wherein determining whether the data-processing device supports the configuration represented by the requested alteration to the configuration data comprises accessing the device processing unit.

32. The method of claim 28 wherein requesting that the configuration processing unit alter the configuration data comprises making the request with the device processing unit.
